(19) United States
(12) Patent Application Publication
(10) Pub. No.: US 2009/0018761 A1
(43) Pub. Date: Jan. 15, 2009

(54) Traffic lane management system

(76) Inventor: Gregory C. Petrisor, Los Angeles, CA (US)

Correspondence Address: Scot A. Reader, Suite 228, 1320 Pearl Street, Boulder, CO, 80302, US

(21) Appl. No.: 12/080,721

(22) Filed: Apr. 4, 2008

Related U.S. Application Data
(60) Provisional application No. 60/921,991, filed on Apr. 5, 2007.

(51) Int. Cl. G08G 1/017

(52) U.S. Cl. 701/118

(57) ABSTRACT

A management system for a managed vehicle traffic lane adaptively and selectively extends authorization to use the lane to lower priority vehicle service classes when extension can be done without adversely impacting higher priority vehicle service classes. The management system offers significant quality of life improvement for motorists in congested urban areas by improving throughput of managed and unmanaged lanes and reducing travel times and fuel consumption.

### CROSS-REFERENCE TO RELATED APPLICATION(S)

This application claims priority benefits under 35 U.S.C. 119(e) from U.S. provisional patent application Ser. No. 60/921,991, filed Apr. 5, 2007, entitled “SERVICE LEVEL CONGESTION MANAGEMENT SYSTEM”.

### BACKGROUND OF INVENTION

The present invention relates to a management system for a managed vehicle traffic lane, such as a high occupancy vehicle (HOV) lane, and more particularly to a management system for a managed vehicle traffic lane that adaptively and selectively extends authorization to use the lane to lower priority vehicle service classes when extension can be done without adversely impacting higher priority vehicle service classes.

Traffic congestion has become a significant impediment to the quality of life in urban areas. Physical road capacity (lane miles) of the nation's roadway system has grown slowly over the last quarter century whereas vehicle miles traveled have grown rapidly over the some period. The United States Department of Transportation (USDOT) has indicated that there are insufficient transportation resources to build additional physical road capacity at a rate to keep up with demand. High costs to add physical road capacity and long timelines for deployment have led to anemic growth in physical road capacity in urban areas.

USDOT has promoted carpooling as an alternative to adding road capacity. To promote car pooling, USDOT has incentivized states to create HOV lanes, more commonly known as carpool lanes, whose lawful usage is typically limited to vehicles with multiple occupants. As a result, most states now have networks of HOV lanes in congested areas. In the peak of rush hour conditions, these HOV lanes may at times reach full capacity. However, there is often a significant amount of excess capacity that goes unutilized even during rush hour conditions. Some states have liberalized access to HOV lanes in order to use some of this excess capacity. For example, California has issued stickers to owners of qualifying hybrid vehicles that allow these vehicles to lawfully access HOV lanes even when carrying a single occupant. This has led to greater utilization of HOV lanes; however, in congested areas it has adversely impacted carpoolers.

Additionally, several variants of high occupancy tolling (HOT lone tolling) have been proposed and deployed that allow utilization of excess HOV lane capacity by single occupant vehicles on a charge basis. These systems have generally required installation of a radio frequency identification (RFID) tags in single occupant vehicles and the deployment of periodic gantries along the road with signage that announces current toll rates. RFID readers in the gantries read the RFID tags in passing vehicles and charge the single occupant for use of the HOV lane, monitor current congestion, and dynamically adjust HOV lane toll rates for single occupant vehicles in response to current congestion. One downslide of these systems is that they are costly to deploy. On-board equipment must be installed in the single occupant vehicles. Moreover, if the density of RFID readers is too low, single occupant vehicles can exit the HOV lane in front of the reader and reenter immediately after the reader to avoid a charge. Furthermore, since RFID tags are often not visible to law enforcement officers, regulation of access to HOV lanes by non-paying single occupant vehicles is difficult. More advanced systems that rely on wireless communications systems and global positioning systems (GPS) may eventually address some of the limitations of the RFID based systems. However, these systems are not expected to be broadly deployed for several years.

### SUMMARY OF THE INVENTION

The present invention, in a basic feature, provides a management system for a managed vehicle traffic lone that adaptively and selectively extends authorization to use the lane to lower priority vehicle service classes when such extension can be done without adversely impacting higher priority vehicle service classes. The management system offers significant quality of life improvement for drivers in congested urban areas by improving throughput of managed and unmanaged lanes and reducing travel times and fuel consumption.

In one aspect of the invention, a management system for a managed vehicle traffic lone comprises a detection system and a control system communicatively coupled with the detection system, wherein the control system dynamically regulates authorization to use the lane by at least one vehicle service class of a plurality of discrete vehicle service classes based on congestion information collected from the lane by the detection system.

In some embodiments, the management system further comprises an authorization announcement system communicatively coupled with the control system, wherein the authorization announcement system provides notification of authorization status of at least one of a plurality of vehicle service classes. In some embodiments, the authorization announcement system comprises at least one of a roadside sign or an on-vehicle display or speaker.

In some embodiments, the management system further comprises a service class announcement system, wherein the service class announcement system provides notification of a service class to which a vehicle belongs. In some embodiments, the service class announcement system comprises at least one of a bumper sticker, window sticker, contactless identification system (e.g. RFID) or wireless communication system.

In some embodiments, the detection system comprises at least one of an inductive loop detection system, a visual detection system, a contactless identification detection system or a wireless probe vehicle-based system.

In some embodiments, the control system extends authorization to use the lane to the at least one vehicle service class in response to an indication in the congestion information that congestion has fallen below a predetermined threshold.

In some embodiments, the control system denies authorization to use the lane to the at least one vehicle service class in response to an indication in the congestion information that congestion has risen above a predetermined threshold.

In some embodiments, the plurality of discrete vehicle service classes is prioritized and the control system dynamically regulates authorization to use the lane to the at least one vehicle service class based on priority.

In some embodiments, the plurality of vehicle services classes comprises at least one of a class for HOV with four or four or more or more occupants, a class for HOV with three or three or more occupants, a class for HOV with two or two or more occupants or a class for qualified single occupant vehicles, such as alternative fuel vehicles, hybrid vehicles or vehicles in which the single occupant has become qualified through a lottery, auction or purchase of a permit.

In another aspect of the invention, a method for managing a managed vehicle traffic lane comprises the steps of collecting congestion information from the lane and dynamically regulating authorization to use the lane by at least one of a plurality of discrete vehicle service classes based on the collected congestion information.

These and other aspects of the invention will be better understood by reference to the following detailed description taken in conjunction with the drawings that are briefly described below.

### BRIEF DESCRIPTION OF THE DRAWINGS

FIG. 1 shows a management system for a managed vehicle traffic lane in some embodiments of the invention.

FIG. 2 shows a roadside sign for the managed vehicle traffic lane of FIG. 1.

FIG. 3 shows a bumper sticker for a vehicle on the managed vehicle traffic lane of FIG. 1.

FIG. 4 shows a management method for a managed vehicle traffic lane in some embodiments of the invention.

### DETAILED DESCRIPTION OF A PREFERRED EMBODIMENT

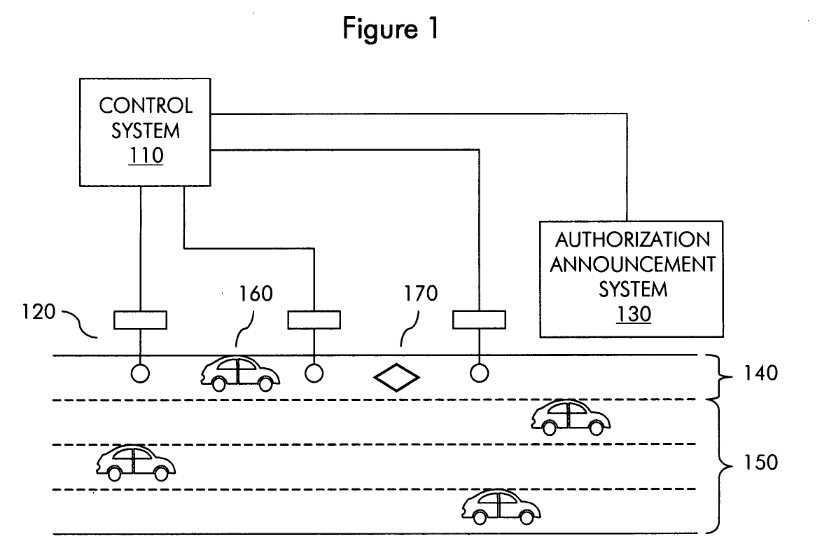

FIG. 1 shows a management system for a managed vehicle traffic lane in some embodiments of the invention. The management system manages a managed lane 140 on a road that has managed lane 140 and a multiple of unmanaged lanes 150. Unmanaged lanes 150 can be lawfully used by all vehicles at all times when unmanaged lanes 150 are in service. Managed lane 140, however, can be lawfully used only by vehicles belonging to vehicle service classes that are presently authorized to use managed lane 140. Authorization of a plurality of prioritized discrete vehicle service classes to use managed lane 140 is dynamically regulated by the management system based on current congestion in managed lane 140. Managed lane 140 has roadway markings (e.g. 170) to help the drivers of vehicles (e.g. 160) easily identify managed lane 140 as managed.

A detection system 120 continually collects congestion information from managed lane 140 and transmits the congestion information to a control system 110. Detection system 120 in the illustrated embodiment is an inductive loop detection system that includes multiple loop detectors evenly-spaced along managed lane 140 for measuring the flow of traffic in managed lane 140, although in other embodiments of the invention a visual detection system, a contactless identification detection system or a wireless probe vehicle-based system may be deployed.

Control system 110 continually determines which vehicle service classes are presently authorized to use managed lane 140 based on congestion information received from detection system 120. Control system 110 hosts and executes a managed lane control application for determining which vehicle service classes are presently authorized. In some embodiments, control system 110 resides in a network operation center remote from managed lane 140 and manages multiple managed lanes based on congestion information received from multiple detection systems.

Control system 110 transmits authorization information to authorization announcement system 130 in response to a change in the vehicle service classes that are presently authorized to use managed lane 140. For example, in some embodiments control system 110 has a database with different predetermined congestion thresholds for different vehicle service classes that control system 110 uses to determine present authorizations. Higher priority vehicle service classes have higher congestion thresholds. When congestion information received from detection system 120 indicates an increase in congestion on managed lane 140 to a point that congestion surpasses a congestion threshold for a presently authorized vehicle service class, control system 110 notifies authorization announcement system 130 that authorization for that vehicle service class to use managed lane 140 is revoked. Similarly, when congestion information received from detection system 120 indicates a decrease in congestion on managed lane 140 to a point that congestion falls below a congestion threshold for a presently unauthorized vehicle service class, control system 11O notifies authorization announcement system 130 that authorization for that. vehicle service class to use managed lane 140 is restored. If control system 110 determines that congestion on managed lane 140 has not changed to a point where there is a change in the vehicle service classes that are authorized to use managed lane 140, control system 110 does not notify authorization announcement system 130.

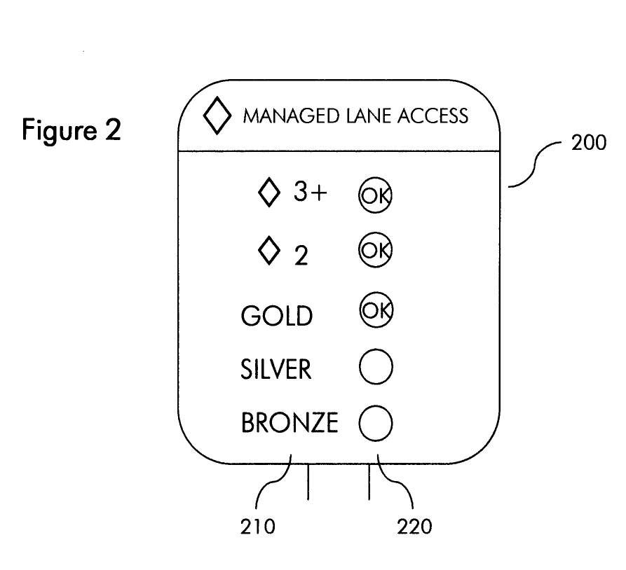

Authorization announcement system 130 announces which vehicle service classes are presently authorized to use managed lane 140 in a manner that is conspicuous to drivers of vehicles (e.g. vehicle 160). Turning to FIG. 2, authorization announcement system 130 is shown to include a roadside sign 200. Sign 200 displays discrete vehicle service class designations 210 and present authorizations 220. In the illustrated embodiment, sign 200 displays five vehicle service class designations 210 in descending order of priority, as follows: HOV with three or more occupants (HOV-3+), HOV with two occupants (HOV-2), single occupant Gold Level Pay, single occupant Silver Level Pay and single occupant Bronze Level Pay. Authorizations 220 indicate that, based on current congestion, the three highest priority vehicle service classes (HOV-3+, HOV-2, Gold) are presently authorized to access managed lane 140, while the two lowest priority vehicle service classes (Silver, Bronze) are not presently authorized. In other embodiments, authorization announcement system 130 could provide announcements via additional or different means, such as an on-vehicle display or speaker. Moreover, various vehicle service. classes and combinations thereof may be used, for example, a class for HOV with four or four or more occupants, a class for HOV with three or three or more occupants, a class for HOV with two or two or more occupants, and/or various classes for qualified. single occupant vehicles, such as alternative fuel vehicles, hybrid vehicles or vehicles in which the single occupant has become qualified through a lottery, auction or purchase of a permit.

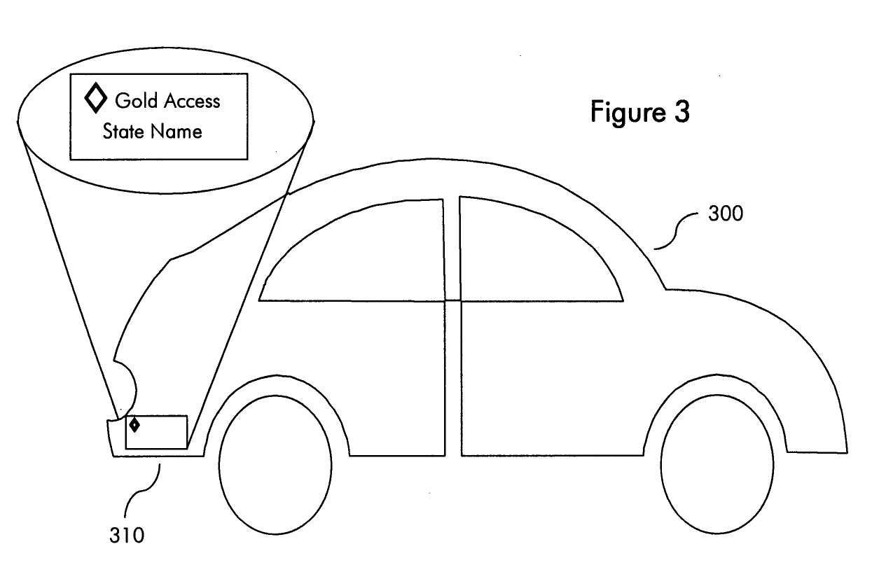

The management system also includes a service class announcement system that provides notification respecting the vehicle service class of vehicles in a manner that is conspicuous to low enforcement or other regulatory entity. Such notification may be used by law enforcement or other regulatory entity to enforce the current vehicle service class authorizations on managed lane 140. FIG. 3 shows a bumper sticker 310 applied to a vehicle 300 on managed lane 140, which is one example of a service class announcement system. Bumper sticker 310 includes an access level (Gold in the example shown) and a state name, from which law enforcement personnel can readily determine whether vehicle 300 (assuming vehicle 300 is not otherwise qualified by virtue of high occupancy) is authorized to use managed lane 140 under current congestion conditions announced by authorization announcement system 130. In other embodiments, a service class announcement system may be based additionally or alternatively on window stickers, a contactless identification system (e.g. an RFID tag identifying a service class that is read by an RFID reader), or a wireless communication system that broadcasts a vehicle service class signal.

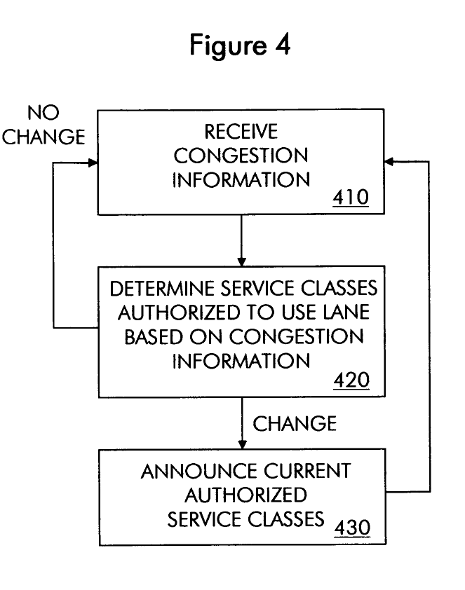

FIG. 4 shows a management method for a managed vehicle traffic lane in some embodiments of the invention. Control system 110 continually receives congestion information collected from managed lane 140 by detection system 120 (410) and determines which vehicle service classes are authorized to use managed lane 140 by reference to the congestion information and predetermined congestion thresholds for the different vehicle service classes (420). When control system 110 identifies a change in authorization of vehicle service classes, control system 110 notifies authorization announcement system 130, which announces the authorized vehicle service classes (430). Law enforcement or other regulatory entity polices use of managed lane 140 in accordance with the announced authorized vehicle service classes.

The components of the systems described above may perform their respective operations using various combinations of custom logic, general purpose logic and software.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A management system for a managed vehicle traffic lane, comprising:
a detection system; and
a control system communicatively coupled with the detection system, wherein the control system dynamically regulates authorization to use the lane by at least one of a plurality of discrete vehicle service classes based on congestion information collected from the lane by the detection system.

2. The management system of claim 1, further comprising an authorization announcement system communicatively coupled with the control system, wherein the authorization announcement system provides notification of authorization status of the at least one vehicle service class.

3. The management system of claim 2, wherein the authorization announcement system comprises a roadside sign.

4. The management system of claim 1, further comprising a service class announcement system, wherein the service class announcement system provides notification of a vehicle service class to which a vehicle belongs.

5. The management system of claim 4, wherein the service class announcement system comprises a bumper sticker.

6. The management system of claim 1, wherein the detection system comprises an inductive loop detection system.

7. The management system of claim 1, wherein the control system extends authorization to use the lane to the at least one vehicle service class in response to an indication in the congestion information that congestion has fallen below a predetermined threshold.

8. The management system of claim 1, wherein the control system denies authorization to use the lane to the at least one vehicle service class in response to an indication in the congestion information that congestion has risen above a predetermined threshold.

9. The management system of claim 1, wherein the plurality of discrete vehicle service classes is prioritized and the control system dynamically regulates authorization to use the lane to the at least one vehicle service class based on priority.

10. The management system of claim 1, wherein the plurality of vehicle services classes comprise at least one class for qualified single occupant vehicles.

11. The management system of claim 10, wherein the at least one class for qualified single occupant vehicles is a class in which qualification is obtained by paying for a permit.

12. A method for managing a managed vehicle traffic lane, comprising the steps of:
collecting congestion information from the lane; and
dynamically regulating authorization to use the lane by at least one of a plurality of discrete vehicle service classes based on the collected congestion information.

13. The method of claim 12, further comprising the step of providing notification of authorization status of the at least one vehicle service class.

14. The method of claim 12, further comprising the step of providing notification of a vehicle service class to which a vehicle belongs.

15. The method of claim 12, wherein the step of dynamically regulating authorization comprises extending authorization to use the lane to the at least one vehicle service class in response to an indication in the congestion information that congestion has fallen below a predetermined threshold.

16. The method of claim 12, wherein the plurality of discrete vehicle service classes is prioritized and the step of dynamically regulating authorization to use the lane to the at least one vehicle service class is based further on priority.

17. The method of claim 12, wherein the step of dynamically regulating authorization comprises denying authorization to use the lane to the at least one vehicle service class in response to an indication in the congestion information that congestion has risen above a predetermined threshold.

18. The method of claim 12, wherein the plurality of vehicle services classes comprises at least one qualified single occupant vehicle service class.
